(19) United States
(12) Patent Application Publication
(10) Pub. No.: US 2016/0269674 A1
(43) Pub. Date: Sep. 15, 2016

(54) Dynamic Video Capture Rate Control

(71) Applicant: Microsoft Technology Licensing, LLC, Redmond, WA (US)

(72) Inventors: Jyotsana Rathore, Kirkland, WA (US); Rinku Sreedhar, Sammamish, WA (US); Lucia Darsa, Clyde Hill, WA (US); Brian Douglas King, Snoqualmie, WA (US); Brian S. Beecher, Rochester Hills, MI (US)

(21) Appl. No.: 14/642,300

(22) Filed: Mar. 9, 2015

(51) Int. Cl. H04N 5/77; H04N 9/82; G11B 27/00; G11B 20/00; G11B 31/00; G11B 27/30

(52) U.S. Cl. CPC H04N 5/772; G11B 31/006; G11B 27/3036; G11B 27/005; G11B 20/00007; H04N 9/82; G11B 2020/00072

(57) ABSTRACT

Dynamic video capture rate control techniques are described. In one or more implementations, a method is described of dynamically controlling video capture rate. Capture of video of a camera is caused by a device to occur at a first rate for a first collection of images in the video. During the causation of the capture of the video at the first rate, an input is detected by the device to change to a second rate that is different than the first rate. Responsive to the detection of the input, the capture rate is changed from the first rate to the second rate, the capture of the video by the camera is caused to occur at the second rate for a second collection of images of the video, and timestamps of the first collection of images or the second collection of images are transformed to configure the image in the video for output at a substantially uniform rate relative to each other.

### BACKGROUND

The availability of video capture to users is ever increasing. For example, video cameras were initially configured as standalone devices having dedicated functionality used to capture video. Although standalone devices are still used, this functionality has expanded for inclusion in a variety of other devices, such as mobile phones, tablet computers, portable gaming devices, and so on.

Functionality available to support video capture has also continued to increase. An example of this includes slow motion playback, such as to slow playback of a particularly interesting play in a sporting event. Conventional mechanisms used to support slow motion playback, however, are often limited to use of a single slow motion playback rate for an entirety of the video.

In other conventional examples, decimation techniques are employed in which frames are removed from the video to support the slow motion playback by removing frames from portions of the video that are to be played at a normal speed. These conventional decimation techniques result in increased resource consumption, e.g., by an encoder that is forced to operate at a rate that is greater than a rate at which the video is to be output. This also results in a decrease in battery life which makes these conventional techniques ill-suited for mobile implementations, e.g., as part of a mobile phone. Also, decimation results in a loss of image information due to the removed frames and thus limits use as part of subsequent video editing operations, e.g., to further modify output rates, splice the video with other videos, and so forth.

### SUMMARY

Dynamic video capture rate control techniques are described. In one or more implementations, a method is described of dynamically controlling video capture rate. Capture of video of a camera is caused by a device to occur at a first rate for a first collection of images in the video. During the causation of the capture of the video at the first rate, an input is detected by the device to change to a second rate that is different than the first rate. Responsive to the detection of the input, the capture rate is changed from the first rate to the second rate, the capture of the video by the camera is caused to occur at the second rate for a second collection of images of the video, and timestamps of the first collection of images or the second collection of images are transformed to configure the image in the video for output at a substantially uniform rate relative to each other.

In one or more implementations, a device is configured to dynamically control video capture rate. The device includes a camera having a camera sensor to capture a plurality of images sequentially, a camera pipeline to control encoding of the plurality of images to form video, and a video manager module implemented at least partially in hardware. The video manager module is configured to cause capture of the video by the camera to occur at a first rate for a first collection of the images in the video, responsive to detection of an input during the capture of the video, the input corresponding to an application of a slow motion effect to a second collection of the images, cause capture of the video by the camera to occur at a second rate for the second collection images, the second rate being greater than the first rate and the capture of the second collection of the images occurring subsequent to the capture of the first collection of the images, and adjust timestamps of the images in the second collection of images to configure the images in the second collection of images for output at a substantially uniform rate relative to the images in the first collection of images.

In one or more implementations, a device is configured to dynamically control video capture rate. The device includes a camera having a camera sensor to capture a plurality of images sequentially, a camera pipeline to control encoding of the plurality of images to form video, and a video manager module implemented at least partially in hardware. The video manager module is configured to cause capture of video by the camera to occur at a capture rate corresponding to a first rate for a first collection of images in the video, during the capture of the video at the first rate, detect an input to change the capture rate from the first rate to a second rate that is different than the first rate, and responsive to the detection of the input change the capture rate from the first rate to the second rate, cause the capture of the video by the camera to occur at the second rate for a second collection of images in the video, and transform timestamps of the first collection of images or the second collection of images to configure the images in the video for output at a substantially uniform rate relative to each other.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ dynamic video capture rate control techniques.

FIG. 2 depicts a system in an example implementation of dynamic video capture rate control as used to support a slow motion playback effect.

FIG. 3 depicts a system in an example implementation in which a video manager module configures the captured images of the video of FIG. 2 for playback as supporting a slow motion effect.

FIG. 4 is a flow diagram depicting a procedure in an example implementation in which dynamic video capture rate control techniques are described.

FIG. 5 is a flow diagram depicting another procedure in an example implementation in which dynamic video capture rate control techniques are described.

FIG. 6 illustrates an example system including various components of an example device that can be implemented as any type of computing device as described with reference to FIGS. 1-5 to implement embodiments of the techniques described herein.

### DETAILED DESCRIPTION

Overview

Conventional techniques used to support slow motion playback often limited this slowdown to a single rate that is applied to an entirety of a video. Although decimation techniques have been developed to support variations in a rate of playback, these techniques involve increased resource consumption on the part of an encoder and battery resources in mobile applications, can result in relative large files in some instances thereby consuming valuable memory resources, and also result in loss of image information due to the removal of the images and thus are ill-suited for use as part of subsequent video editing operations.

Dynamic video capture rate control techniques are described. In one or more examples, a video manager module implements techniques to control configuration of video for output at rates specified by a user during capture of the video dynamically and in real time. The user, for instance, may capture video at a sporting event for output at a “normal” rate. During this capture, the user selects to configure the video for output as part of a slow-motion effect. In response, the video manager module increases a rate at which images are captured by a camera. The video manager module then modifies timestamps of the images to support playback at a normal rate to achieve the slow motion effect.

For example, to support slow motion playback at half speed of normal output a rate of capture is increased to twice a normal capture rate and then configured to output at the normal rate through transformation of the timestamps. Although slow motion playback is described in this example, these techniques are equally applicable to time-lapse playback in which images are captured at a rate that is less than normal playback, may also support changes between different rates, and so forth as further described below.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

### Example Environment

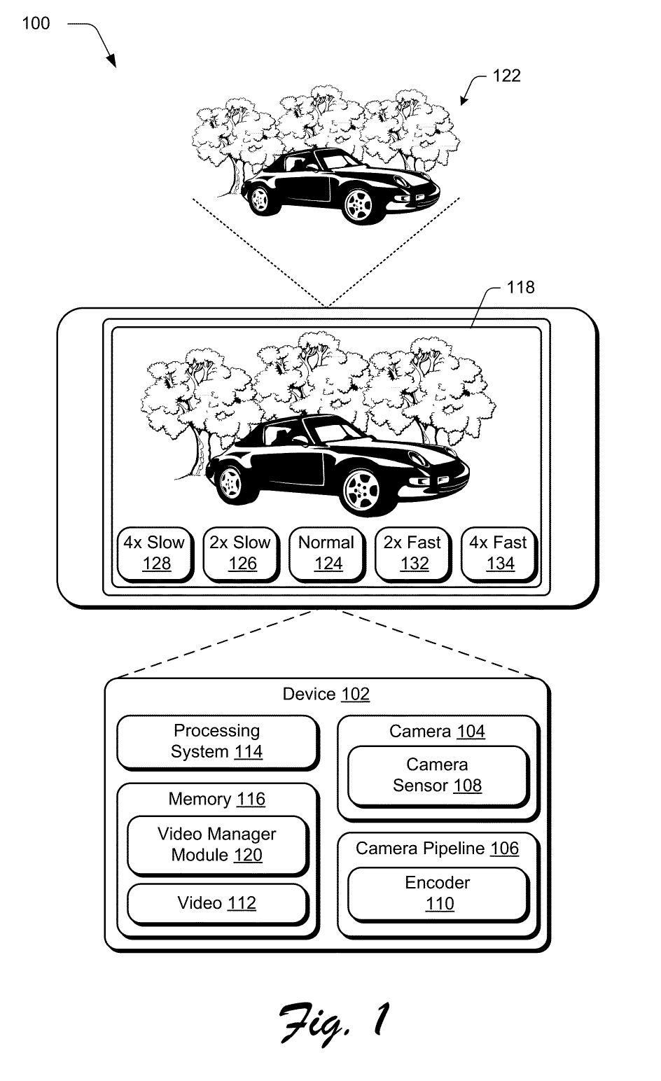

FIG. 1 is an illustration of an environment 100 in an example implementation that is operable to employ the techniques described herein. The illustrated environment 100 includes a device 102 having a camera 104 and a camera pipeline 106, which may be configured in a variety of ways.

For example, the device 102 may be configured as a standalone video camera. In another example, the device 102 is configured as a computing device that includes the camera 104 and camera pipeline 106, such as a mobile communications device (e.g., mobile phone), a tablet computer, a portable game console, and so forth. Thus, the device 102 may range from full resource devices with substantial memory and processor resources (e.g., mobile phones) to a low-resource device with limited memory and/or processing resources (e.g., a standalone camera). Additionally, although a single device 102 is shown, the device 102 may be representative of a plurality of different devices, such as a standalone camera 104 that includes a camera sensor 108 and a camera pipeline 106 as part of a computing device that includes an encoder 110 configured to encode images from a raw format in accordance with one or more standards as video 112.

The device 102 in the illustrated example is illustrated as mobile phone having a variety of hardware components, examples of which include a processing system 114, an example of a computer-readable storage medium illustrated as memory 116, a display device 118, and so on. The processing system 104 is representative of functionality to perform operations through execution of instructions stored in the memory 116. Although illustrated separately, functionality of these components may be further divided, combined (e.g., on an application specific integrated circuit), and so forth.

The memory 116 is further illustrated as maintaining a video manager module 120 and thus is implemented at least partially in hardware and is executable by the processing system 114 to cause performance of one or more operations. Other implementations are also contemplated, such as implementation as a dedicated hardware component, e.g., application specific integrated circuit, fixed-logic circuitry, and so forth.

The video manager module 120 is representation of functionality to implement dynamic video capture rate control of video 112. The video manager module 120, for instance, may cause the camera sensor 108 to capture images of an image scene 122 as video 112.

During this capture, options are displayed in a user interface by the display device 118, via which, a user may interact to specify a desired output (e.g., playback) rate of the video 112 being captured. One example is illustrated as normal 124 that is selectable to specify a normal output rate, i.e., playback is performed as if captured in real time as it is received without modification. Options to specify different amounts of slow motion playback are also illustrated, such as “2× Slow” 126 and “4× Slow” 128 thereby indicating different amounts the playback is to appear as being slowed. Other options to speed up the playback (i.e., as a time-lapse) are also illustrated, such as “2× Fast” 124 and “4× Fast.”

In response, the video manager module 120 is configured to control a rate at which images of the video 112 are captured by the camera sensor 108 accordingly such that a desired playback effect may be achieved without decimation (e.g., removal) of images as was required in conventional techniques. In the following, an example of a slow motion playback is described but as should be readily apparent these techniques are equally applicable as time-lapse effects in which output of the video 112 appears to “speed up.” Further discussion of which is described in the following and shown in corresponding figures.

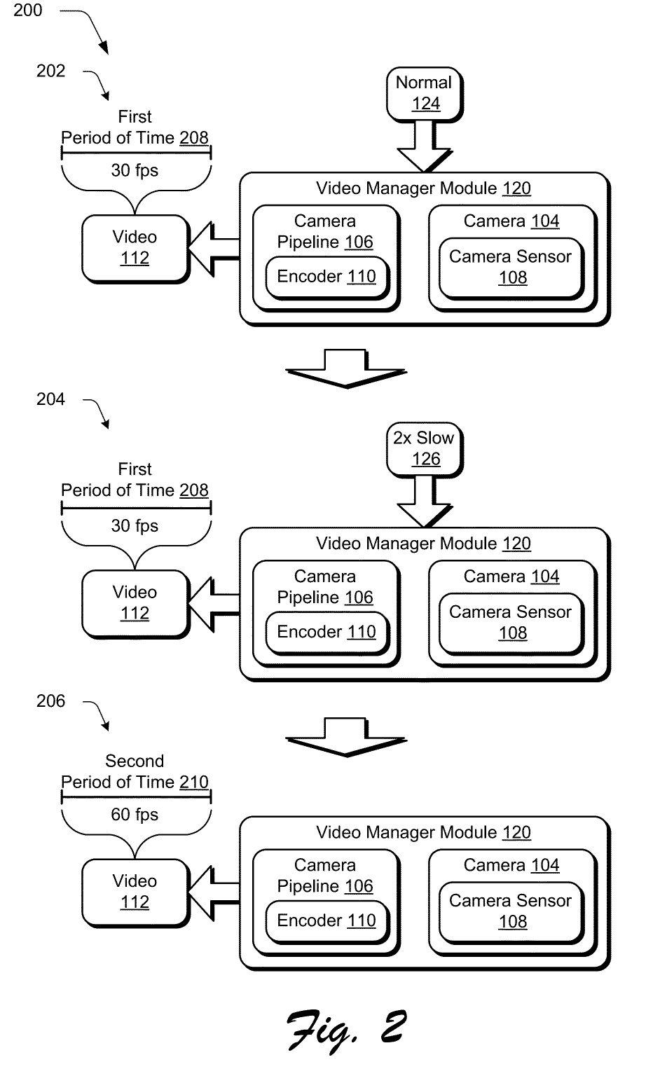

FIG. 2 depicts a system 200 in an example implementation of dynamic video capture rate control as used to support a slow motion playback effect. This system 200 is illustrated using first, second, and third stages 202, 204, 206. At the first stage 202, a video manager module 120 operates at a normal 124 rate of capture such that timestamps associated with images in the video correspond to a rate at which the images are captured by a camera sensor 108 of the camera 104. In other words, the rate at which images are captured matches a rate at which these images are configured for output as part of the video 112. In this example, image capture is performed at this first rate for a first period of time 208 to form a first collection of images as part of the video 112.

At the second stage 204, during capture of the images in the first period of time 208, an input is received (e.g., through selection of the 2x Slow 126 option) to apply a slow motion effect for slow motion playback of a second collection of images for capture after the first period of time 208. Selection of the 2x Slow 126 option, for instance, is usable to indicate that images captured during that time are to be configured for output during an amount of time that is twice as long as an amount of time used to capture the images.

In response, the video manager module 120 increases a rate at which the camera sensor 108 is used to capture images for a second period of time 210, e.g., which is subsequent to the first period of time 208. For example, for the first period of time 208 one second of image capture by the camera sensor 108 produces one second worth of images for output. By increasing the capture rate, the amount of images for output may be increased such that if a same output rate is used a corresponding increase in length is gained based on a number of images captured, such as twice as long in this example for the second period of time 210.

Conventional decimation techniques operated the encoder at a rate greater than a rate at which the images are kept for subsequent output in order to support slow motion playback for other portions of the video, thereby needlessly consuming resources of the device. In the techniques described herein, however, the encoder 110 operates solely for images that are to be included in the subsequent output of the video 112, thereby conserving resources and preserving information in the images to support subsequent video editing techniques.

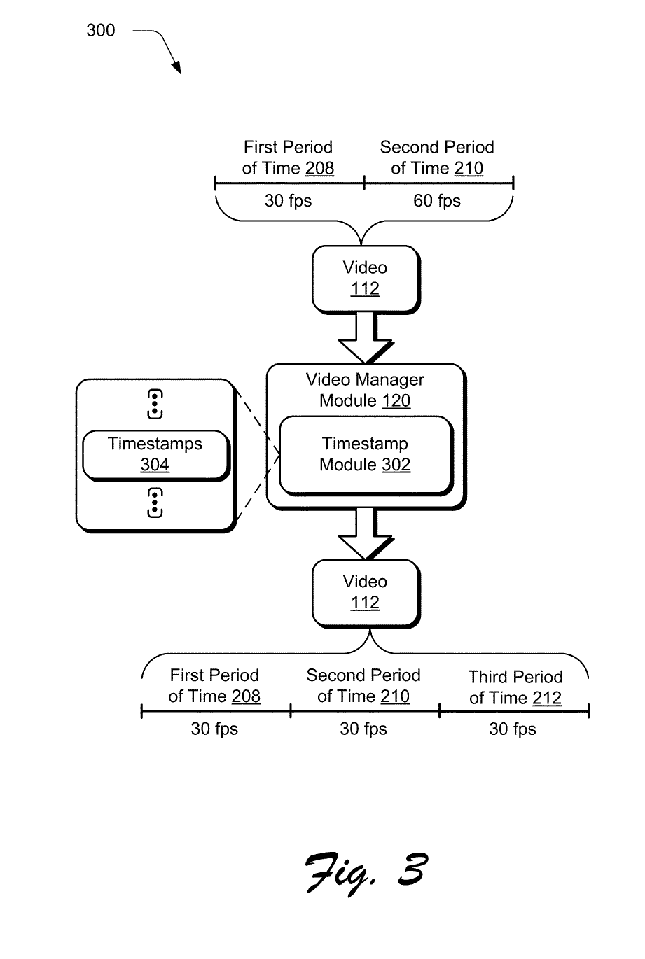

FIG. 3 depicts a system 300 in an example implementation in which the video manager module 120 configures the captured images of the video 112 of FIG. 2 for playback as supporting the slow motion effect. In this example, the video manager module 120 processes the video received from the encoder 110 using a timestamp module 106. The timestamp module 302 is representative of functionality to transform timestamps of images captured by the camera 104 to support a generally uniform output rate.

As previously described, for instance, the first collection of images captured during the first period of time 208 is captured using a first rate of thirty frames-per-second (fps) and the second collection of images captured during the second period of time 210 is captured using a second rate of sixty frames-per-second (fps). The timestamp module 302 then adjusts the timestamps 304 associated with the images to support a uniform playback rate.

Thus, as the timestamps 304 of the first period of time 208 correspond with a normal output rate of 30 fps in this example, the timestamps of the first period of time 208 remain unchanged. In other words, a rate at which the first collection of images is captured matches a rate at which the first collection of images is to be output.

For the second period of time 210, however, the second collection of images is captured at a second rate which is twice as fast as the first rate, e.g., sixty frames-per-second. Accordingly, the timestamps of the images in the second collection are transformed for output during an amount of time that is twice as long as an amount of time used to capture the images, which is illustrated as including the second period of time 210 in which the second collection is output at a rate of thirty frames-per-second and a third period of time 212 during which the output of the second collection continues at a rate of thirty frames per second in this example. In this way, the slow motion playback effect is applied over the second and third periods of time 210, 212 after processing of the timestamps 304 by the timestamp module 302.

As previously described, a variety of other examples of rate changes are also contemplated. For example, rates during the first and second periods of time 208, 210 may both involve capture rates that are different than a set output rate, e.g., the first rate may be greater than a normal rate and the second rate may be less than the normal rate, the first rate may be less than the normal rate and the second rate may be greater, both may be less or greater than a normal rate, either one may be captured at a normal rate, and so on. Further discussion of these and other examples is described in relation to the following procedures and shown in corresponding drawings.

### Example Procedures

The following discussion describes dynamic video capture rate control techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the figures described above.

Functionality, features, and concepts described in relation to the examples of FIGS. 1-3 may be employed in the context of the procedures described herein. Further, functionality, features, and concepts described in relation to different procedures below may be interchanged among the different procedures and are not limited to implementation in the context of an individual procedure. Moreover, blocks associated with different representative procedures and corresponding figures herein may be applied together and/or combined in different ways. Thus, individual functionality, features, and concepts described in relation to different example environments, devices, components, and procedures herein may be used in any suitable combinations and are not limited to the particular combinations represented by the enumerated examples.

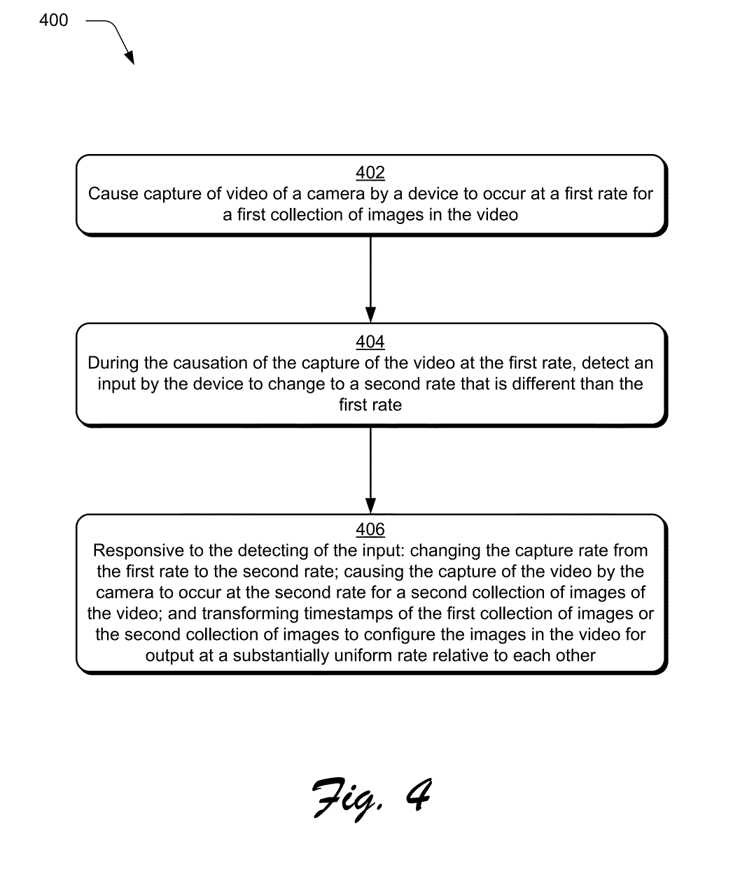

FIG. 4 depicts a procedure 400 in an example implementation of dynamic video capture rate control techniques. A method is described of dynamically controlling video capture rate without loss of image information. Capture of video of a camera is caused by a device to occur at a first rate for a first collection of images in the video (block 402). The first rate, for instance, may be set at a normal rate such that a rate of capture matches a desired rate of output, may be faster or slower than normal, and so on.

During the causation of the capture of the video at the first rate, an input is detected by the device to change to a second rate that is different than the first rate (block 404). A user, for instance, may press a button, select an option displayed by the display device 118, and so on that is detected by the video manager module 120 of the device 102.

Responsive to the detection of the input, the capture rate is changed from the first rate to the second rate, the capture of the video by the camera is caused to occur at the second rate for a second collection of of images of the video, and timestamps of the first collection of images or the second collection of images are transformed to configure the image in the video for output at a substantially uniform rate relative to each other (block 406). The video manager module 120, for instance, sets a rate of capture by the camera sensor 108 that provides a desired number of images to be captured during a period of time that are then normalized for output to provide a slow motion effect, time lapse effect, and so on. Additionally, the video manager module 120 may cause this switch by the camera sensor 108 to occur without rebooting the sensor, which was required to perform changes in capture rates, conventionally.

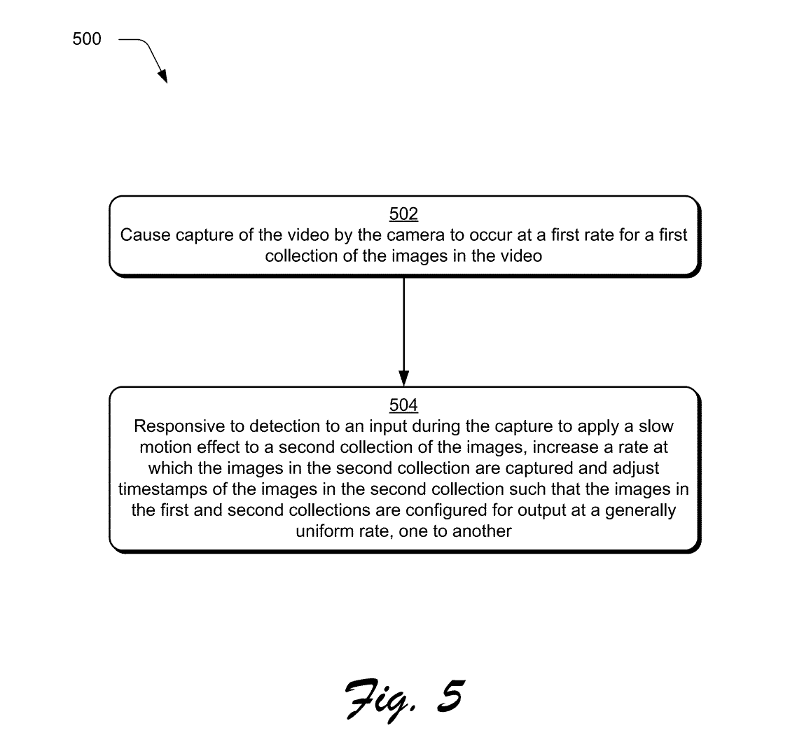

FIG. 5 depicts a procedure 500 in another example implementation of dynamic video capture rate control techniques. A video manager module is configured to cause capture of the video by the camera to occur at a first rate for a first collection of the images in the video (block 502). As before, the first rate may be set at a normal rate such that a rate of capture matches a desired rate of output, may be faster or slower than normal, and so on.

Responsive to detection to an input during the capture to apply a slow motion effect to a second collection of the images, a rate at which the images in the second collection are captured is increased and timestamps of the images in the second collection are adjusted such that the images in the first and second collections are configured for output at a generally uniform rate, one to another (block 504). As shown in FIGS. 2 and 3, for instance, the second rate of capture for the second collection of images in the video 122 is increased over a second period of time 210. Timestamps 304 of the video 112 are then transformed such that the images are output over a correspondingly longer period of time, e.g., the second period of time 210 and the third period of time 212. Other examples involving time lapse effects are also contemplated.

### Example System and Device

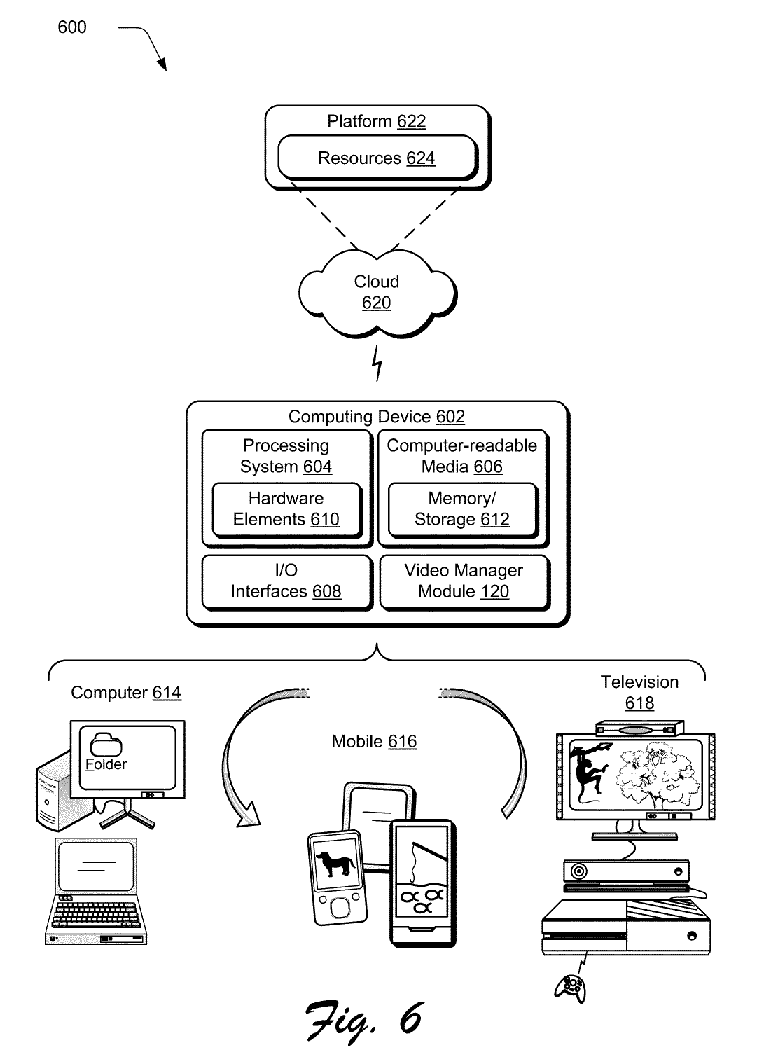

FIG. 6 illustrates an example system generally at 600 that includes an example computing device 602 that is representative of one or more computing systems and/or devices that may implement the various techniques described herein. An example of this is illustrated through inclusion of the video manager module 120. The computing device 602 may be, for example, a server of a service provider, a device associated with a client (e.g., a client device), an on-chip system, and/or any other suitable computing device or computing system.

The example computing device 602 as illustrated includes a processing system 604, one or more computer-readable media 606, and one or more I/O interface 608 that are communicatively coupled, one to another. Although not shown, the computing device 602 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 604 is representative of functionality to perform one or more operations using hardware. Accordingly, the processing system 604 is illustrated as including hardware element 610 that may be configured as processors, functional blocks, and so forth. This may include implementation in hardware as an application specific integrated circuit or other logic device formed using one or more semiconductors. The hardware elements 610 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 606 is illustrated as including memory/storage 612. The memory/storage 612 represents memory/storage capacity associated with one or more computer-readable media. The memory/storage component 612 may include volatile media (such as random access memory (RAM)) and/or nonvolatile media (such as read only memory (ROM), Flash memory, optical disks, magnetic disks, and so forth). The memory/storage component 612 may include fixed media (e.g., RAM, ROM, a fixed hard drive, and so on) as well as removable media (e.g., Flash memory, a removable hard drive, an optical disc, and so forth). The computer-readable media 606 may be configured in a variety of other ways as further described below.

Input/output interface(s) 608 are representative of functionality to allow a user to enter commands and information to computing device 602, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 602 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 602. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 602, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 610 and computer-readable media 606 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 610. The computing device 602 may be configured to implement particular instructions and/or functions corresponding to the software and/or hardware modules. Accordingly, implementation of a module that is executable by the computing device 602 as software may be achieved at least partially in hardware, e.g., through use of computer-readable storage media and/or hardware elements 610 of the processing system 604. The instructions and/or functions may be executable/operable by one or more articles of manufacture (for example, one or more computing devices 602 and/or processing systems 604) to implement techniques, modules, and examples described herein.

As further illustrated in FIG. 6, the example system 600 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 600, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 602 may assume a variety of different configurations, such as for computer 614, mobile 616, and television 618 uses. Each of these configurations includes devices that may have generally different constructs and capabilities, and thus the computing device 602 may be configured according to one or more of the different device classes. For instance, the computing device 602 may be implemented as the computer 614 class of a device that includes a personal computer, desktop computer, a multi-screen computer, laptop computer, netbook, and so on.

The computing device 602 may also be implemented as the mobile 616 class of device that includes mobile devices, such as a mobile phone, portable music player, portable gaming device, a tablet computer, a multi-screen computer, and so on. The computing device 602 may also be implemented as the television 618 class of device that includes devices having or connected to generally larger screens in casual viewing environments. These devices include televisions, set-top boxes, gaming consoles, and so on.

The techniques described herein may be supported by these various configurations of the computing device 602 and are not limited to the specific examples of the techniques described herein. This functionality may also be implemented all or in part through use of a distributed system, such as over a “cloud” 620 via a platform 622 as described below.

The cloud 620 includes and/or is representative of a platform 622 for resources 624. The platform 622 abstracts underlying functionality of hardware (e.g., servers) and software resources of the cloud 620. The resources 624 may include applications and/or data that can be utilized while computer processing is executed on servers that are remote from the computing device 602. Resources 624 can also include services provided over the Internet and/or through a subscriber network, such as a cellular or Wi-Fi network.

The platform 622 may abstract resources and functions to connect the computing device 602 with other computing devices. The platform 622 may also serve to abstract scaling of resources to provide a corresponding level of scale to encountered demand for the resources 624 that are implemented via the platform 622. Accordingly, in an interconnected device embodiment, implementation of functionality described herein may be distributed throughout the system 600. For example, the functionality may be implemented in part on the computing device 602 as well as via the platform 622 that abstracts the functionality of the cloud 620.

### Conclusion and Example Implementations

Example implementations described herein include, but are not limited to, one or any combinations of one or more of the following examples:

In one or more examples, a method is described of dynamically controlling video capture rate without loss of image information. Capture of video of a camera is caused by a device to occur at a first rate for a first collection of images in the video. During the causation of the capture of the video at the first rate, an input is detected by the device to change to a second rate that is different than the first rate. Responsive to the detection of the input, the capture rate is changed from the first rate to the second rate, the capture of the video by the camera is caused to occur at the second rate for a second collection of images of the video, and timestamps of the first collection of images or the second collection of images are transformed to configure the image in the video for output at a substantially uniform rate relative to each other.

An example as described alone or in combination with any of the above or below examples, wherein configuring the images in the video for output at the substantially uniform rate relative to each other comprises configuring the images in the video without decimating the video.

An example as described alone or in combination with any of the above or below examples, wherein causing the capture of the video by the camera at the first rate and the second rate, respectively, further comprises encoding, by an encoder of a camera pipeline of the device, the images captured at the first rate and second rate, respectively, as the images are captured.

An example as described alone or in combination with any of the above or below examples, wherein the input corresponds to slow motion playback and the second rate is greater than the first rate.

An example as described alone or in combination with any of the above or below examples, wherein the input corresponds to time-lapse playback and the second rate is less than the first rate.

An example as described alone or in combination with any of the above or below examples, wherein changing the capture rate from the first rate to the second rate is performed without rebooting a camera sensor.

An example as described alone or in combination with any of the above or below examples, wherein the device is one of a mobile phone, a tablet computer, or a standalone camera.

An example as described alone or in combination with any of the above or below examples, further comprising storing the video having the transformed timestamps in memory of the device.

An example as described alone or in combination with any of the above or below examples, further comprising displaying the video having the transformed timestamps by a display device.

In one or more examples, a device is configured to dynamically control video capture rate. The device includes a camera having a camera sensor to capture a plurality of images sequentially, a camera pipeline to control encoding of the plurality of images to form video, and a video manager module implemented at least partially in hardware. The video manager module is configured to cause capture of the video by the camera to occur at a first rate for a first collection of the images in the video, responsive to detection of an input during the capture of the video, the input corresponding to an application of a slow motion effect to a second collection of the images, cause capture of the video by the camera to occur at a second rate for the second collection images, the second rate being greater than the first rate and the capture of the second collection of the images occurring subsequent to the capture of the first collection of the images, and adjust timestamps of the images in the second collection of images to configure the images in the second collection of images for output at a substantially uniform rate relative to the images in the first collection of images.

An example as described alone or in combination with any of the above or below examples, wherein configuring the images in the video for output at the substantially uniform rate relative to each other comprises configuring the images in the video without decimating the video.

An example as described alone or in combination with any of the above or below examples, wherein causing the capture of the video by the camera at the first rate and the second rate, respectively, further comprises encoding, by an encoder of a camera pipeline of the device, the images captured at the first rate and second rate, respectively, as the images are captured.

An example as described alone or in combination with any of the above or below examples, wherein the camera sensor is configured to switch from the first rate to the second rate without performing a reboot.

In one or more implementations, a device is configured to dynamically control video capture rate. The device includes a camera having a camera sensor to capture a plurality of images sequentially, a camera pipeline to control encoding of the plurality of images to form video, and a video manager module implemented at least partially in hardware. The video manager module is configured to cause capture of video by the camera to occur at a capture rate corresponding to a first rate for a first collection of images in the video, during the capture of the video at the first rate, detect an input to change the capture rate from the first rate to a second rate that is different than the first rate, and responsive to the detection of the input change the capture rate from the first rate to the second rate, cause the capture of the video by the camera to occur at the second rate for a second collection of images in the video, and transform timestamps of the first collection of images or the second collection of images to configure the images in the video for output at a substantially uniform rate relative to each other.

An example as described alone or in combination with any of the above or below examples, wherein configuring the images in the video for output at the substantially uniform rate relative to each other comprises configuring the images in the video without decimating the video.

An example as described alone or in combination with any of the above or below examples, wherein causing the capture of the video by the camera at the first rate and the second rate, respectively, further comprises encoding, by an encoder of a camera pipeline of the device, the images captured at the first rate and second rate, respectively, as the images are captured.

An example as described alone or in combination with any of the above or below examples, wherein the input corresponds to slow motion playback and the second rate is greater than the first rate.

An example as described alone or in combination with any of the above or below examples, wherein the input corresponds to time-lapse playback and the second rate is less than the first rate.

An example as described alone or in combination with any of the above or below examples, wherein the camera sensor is further configured to change from the first rate to the second rate without performing a reboot.

An example as described alone or in combination with any of the above or below examples, wherein the substantially uniform rate substantially corresponds to the first rate.

Although the example implementations have been described in language specific to structural features and/or methodological acts, it is to be understood that the implementations defined in the appended claims is not necessarily limited to the specific features or acts described. Rather, the specific features and acts are disclosed as example forms of implementing the claimed features.

What is claimed is:

1. A method of dynamically controlling video capture rate, the method comprising:
causing capture of video by a camera of a device to occur at a capture rate corresponding to a first rate for a first collection of images in the video;
during the causing of the capture of the video at the first rate, detecting an input to change the capture rate from the first rate to a second rate that is different than the first rate; and
responsive to the detecting of the input:
changing the capture rate from the first rate to the second rate;
causing the capture of the video by the camera to occur at the second rate for a second collection of images of the video; and
transforming timestamps of the first collection of images or the second collection of images to configure the images in the video for output at a substantially uniform rate relative to each other.

2. A method as described in claim 1, wherein configuring the images in the video for output at the substantially uniform rate relative to each other comprises configuring the images in the video without decimating the video.

3. A method as described in claim 1, wherein causing the capture of the video by the camera at the first rate and the second rate, respectively, further comprises encoding, by an encoder of a camera pipeline of the device, the images captured at the first rate and second rate, respectively, as the images are captured.

4. A method as described in claim 1, wherein the input corresponds to slow motion playback and the second rate is greater than the first rate.

5. A method as described in claim 1, wherein the input corresponds to time-lapse playback and the second rate is less than the first rate.

6. A method as described in claim 1, wherein changing the capture rate from the first rate to the second rate is performed without rebooting a camera sensor.

7. A method as described in claim 1, wherein the device is one of a mobile phone, a tablet computer, or a standalone camera.

8. A method as described in claim 1, further comprising storing the video having the transformed timestamps in memory of the device.

9. A method as described in claim 1, further comprising displaying the video having the transformed timestamps by a display device.

10. A device configured to dynamically control video capture rate, the device comprising:
a camera comprising a camera sensor configured to sequentially capture images;
a camera pipeline configured to control encoding of the images to form captured video; and
a video manager module implemented at least partially in hardware, the video manager module configured to:
cause capture of the video by the camera to occur at a first rate for a first collection of the images in the video;
responsive to detection of an input during the capture of the video, the input corresponding to an application of a slow motion effect to a second collection of the images, cause capture of the video by the camera to occur at a second rate for the second collection images, the second rate being greater than the first rate and the capture of the second collection of the images occurring subsequent to the capture of the first collection of the images; and
adjust timestamps of the images in the second collection of images to configure the images in the second collection of images for output at a substantially uniform rate relative to the images in the first collection of images.

11. A device as described in claim 10, wherein configuring the images in the video for output at the substantially uniform rate relative to each other comprises configuring the images in the video without decimating the video.

12. A device as described in claim 10, wherein causing the capture of the video by the camera at the first rate and the second rate, respectively, further comprises encoding, by an encoder of a camera pipeline of the device, the images captured at the first rate and second rate, respectively, as the images are captured.

13. A device as described in claim 10, wherein the camera sensor is configured to switch from the first rate to the second rate without performing a reboot.

14. A device configured to dynamically control video capture rate, the device comprising:
a camera having a camera sensor configured to sequentially capture a plurality of images;
a camera pipeline configured to control encoding of the plurality of images to form captured video; and
a video manager module implemented at least partially in hardware, the video manager module configured to:
cause capture of video by the camera to occur at a capture rate corresponding to a first rate for a first collection of images in the video;
during the capture of the video at the first rate, detect an input to change the capture rate from the first rate to a second rate that is different than the first rate; and
responsive to the detection of the input:
change the capture rate from the first rate to the second rate;
cause the capture of the video by the camera to occur at the second rate for a second collection of images in the video; and
transform timestamps of the first collection of images or the second collection of images to configure the images in the video for output at a substantially uniform rate relative to each other.

15. A device as described in claim 14, wherein configuring the images in the video for output at the substantially uniform rate relative to each other comprises configuring the images in the video without decimating the video.

16. A device as described in claim 14, wherein causing the capture of the video by the camera at the first rate and the second rate, respectively, further comprises encoding, by an encoder of a camera pipeline of the device, the images captured at the first rate and second rate, respectively, as the images are captured.

17. A device as described in claim 14, wherein the input corresponds to slow motion playback and the second rate is greater than the first rate.

18. A device as described in claim 14, wherein the input corresponds to time-lapse playback and the second rate is less than the first rate.

19. A device as described in claim 14, wherein the camera sensor is further configured to change from the first rate to the second rate without performing a reboot.

20. A device as described in claim 14, wherein the substantially uniform rate substantially corresponds to the first rate.
